(19) United States
(12) Patent Application Publication
(10) Pub. No.: US 2021/0326563 A1
(43) Pub. Date: Oct. 21, 2021

(54) ELECTRONIC FINGERPRINT DEVICE FOR IDENTIFYING PERPETRATORS AND WITNESSES OF A CRIME AND METHOD THEREOF

(71) Applicant: Christopher Gordon Kossor, Kenilworth, NJ (US)

(72) Inventor: Christopher Gordon Kossor, Kenilworth, NJ (US)

(21) Appl. No.: 17/324,071

(22) Filed: May 18, 2021

Related U.S. Application Data
(63) Continuation-in-part of application No. 16/447,857, filed on Jun. 20, 2019, now abandoned.

(51) Int. Cl. G06K 9/00; G08B 25/00; G10L 17/00

(52) U.S. Cl. CPC G06K 9/0008; G10L 17/00; G08B 25/004; G06K 9/00013

(57) ABSTRACT

The present embodiment relates generally to the protection of life and property. More specifically, the present invention may take the form of a personal security device that provides a non-violent means to deter aggressors though novel use of ubiquitous electronic communication devices. This is accomplished by systematically collecting and preserving pertinent artifacts relevant to the crime when initiated by overt or covert queue. This application can be used in a home, retail store, building, or structure as well. If a security sensor is triggered such as a door or window sensor then the application will then collect the digital fingerprints as previously discussed. This embodiment can increase the ability of law enforcement to search and find witnesses and criminals responsible for their actions.

### RELATED APPLICATIONS

This application is a Continuation-In-Part of U.S. application Ser. No. 16/447,857, filed Jun. 20, 2019, which claims the benefit of priority of U.S. Application Ser. No. 62/689,681, filed Jun. 25 2018, is herein incorporated by reference to the present application.

### FIELD OF THE INVENTION

The present embodiment relates generally to the protection of life and property. More specifically, the present invention may take the form of a personal security device that provides a non-violent means to deter aggressors though novel use of ubiquitous electronic communication devices. This is accomplished by systematically collecting and preserving pertinent artifacts relevant to the crime when initiated by overt or covert queue. This application can be used in a home, retail store, building, or structure as well. If a security sensor is triggered such as a door or window opening sensor then the application will then collect the digital fingerprints as previously discussed. This embodiment can increase the ability of law enforcement to search and find witnesses and criminals responsible for their actions.

### BACKGROUND

Physical assault, sexual assault and abductions are deplorable acts of violence especially when involving children. These despicable acts of violence often result in the harm or death of the victim with few clues who the perpetrator or perpetrators are. Perpetrators remain mute of their crimes due to the heinous nature especially in cases of repeat offenders. Witnesses may not come forward because they are unaware a crime was committed or reluctant to come forward to describe who or what they saw. Authorities are challenged with solving these heinous crimes without witnesses, few clues and no leads to follow. Grieving families are left struggling to seek justice and closure of these senseless vile crimes but all too often never achieve either. These despicable acts occur with alarming frequency due to the perceived defenselessness of victims as easy prey. Technology has advanced to make security cameras affordable and deployable in residences and businesses, but of limited effectiveness in many instances.

Almost every person carries a mobile device on their person wherever they go every day. In many scenarios, a mobile device is not utilized to its fullest potential. Of course the mobile phone can be used to call an emergency service such as the emergency phone line, 911, or attempt communication to a close friend or family member. If a communication is terminated prematurely, the emergency service headquarters is only left with a short clip of information. Due to the Auto Number Identification (ANI) and Auto Location Identification (ALI) systems, the headquarters will receive the name and the general location for the appropriate dispatcher to arrive on scene. Most mobile phones employ Global Positioning Systems (GPS), but not all emergency headquarters have the capability to receive this data. With the present methods of retrieving data from a 911 call, there is no information regarding who was involved, who was nearby, and the exact location.

Every crime is different in regards to a victim having accessibility to their phone, and even if a victim of a crime had access to a mobile phone, he or she could be hesitant in overtly stumbling for their mobile phone, turning on the screen, and dialing 911 into the emergency call keypad depending on the actual crime. For example, in a hostage situation, a victim may not even be able to have their phone on their person or talk into their phone. Currently, a person only is able to initiate a call to emergency services through physically turning on their phone and dialing the number. This restricts victims that are put into situations that do not have the ability to physically touch their phone in specific crimes. For example, in some scenarios, victims could get their phone taken away from them by the criminal or perhaps the victim does not want alert the criminal by having a conversation via a verbal conversation in fear of angering the criminal. Prior art has limited ways of initiating a call to emergency services and more importantly, have no way of identifying witnesses and possible criminals in the nearby proximity.

### BRIEF SUMMARY OF THE INVENTION

In one aspect, the present embodiment serves to give mobile phone users the ability to launch this protective application and alert emergency services either verbally, a sudden jerk of motion, specific key sequence or a specific screen swipe. Many crime situations do not allow victims to have access to their phones, as discussed previously in the background. With this present embodiment, the user can use these methods of activation to discreetly launch this application that may not only initiates a call to emergency services, but also initiates collection of all pertinent information of nearby digital signals with the objective of capturing information capable of identifying the individuals who may be the perpetrator or witnesses of criminal activity or behavior.

In another aspect, once the present embodiment is activated, as previously discussed, the present embodiment can capture audio, video, and photographic records via the mobile phones' hardware. Additionally, the GPS location, time, date is also captured as per the mobile phone. Lastly, the unique and traceable electronic fingerprints such as, but not limited to, IMEI, IMSI, MEID, SSID, ESN, Bluetooth®, MAC Addresses, and Wi-Fi addresses, and signal strength of each electronic devices possessed by potential witnesses or perpetrators in the immediate vicinity where a crime was committed are captured. All of this data is sent immediately to an online storage cloud that is secured even in the event the device running the application is ceased, disabled, or destroyed.

In another aspect, the present embodiment is to assist the investigation to establish who may have been involved or have knowledge of what happened. Signal strength of each digital fingerprint is used to determine the origins within the proximity of the device using the application, the present embodiment. The objective is to narrow down the possible devices that the criminal may have on their body. The stronger the signal indicates closer distance to the victim and a greater chance of narrowing down who the perpetrator is. The online storage base cloud would provide law enforcement a myriad of data to search through to obtain a possible perpetrator or witness. The data captured and stored in the cloud could be made accessible only law enforcement with appropriate search warrant in the event of civil liberty privacy concerns. The goal of collecting electronic fingerprints is to trace the collected data via service provider to account holder or physical owner of the hardware.

In another aspect, the present embodiment can also be adapted to be used within infrastructure. A computer can be programmed to function with said embodiment using with a security sensor such as fire alarm, motion sensor, window and door opening monitors, glass breakage or gunshot sensor as examples. Similar to the application on a mobile phone, the process would function inside a building or structure and the device that is operating the application will scan the nearby signals and strength to get the digital fingerprints of potential perpetrators or witnesses in the vicinity once activated.

In another aspect of the present embodiment is the ability for the application to act as a deterrent to criminals. The mere existence of the application of the present invention can serve as a strong deterrent against crime when adopted and deployed ubiquitously as standard configuration on every mobile device.

In yet another aspect of the present embodiment, an electronic fingerprint capturing device for identifying one or more potential perpetrators and witnesses of a crime, the electronic fingerprint capturing device including a display, a microprocessor, a memory component for storing software application data, a data entry component, a network communication device, a video audio capture device, a microphone, a speaker, an accelerometer, and a GPS module; and an electronic fingerprints application installed in the memory component by a user and executed by the microprocessor, the electronic fingerprints application is configured to be activated by the user, the electronic fingerprints application causes the microprocessor to place the electronic fingerprint capturing device in a data acquisition mode upon detection of a trigger activation mechanism; systematically collect and capture a plurality of pertinent data artifacts relevant to the crime when the electronic fingerprint capturing device is within transmission capture range of the one or more mobile devices carried by the one or more potential perpetrators and witnesses; and communicate and transfer the plurality of pertinent data artifacts to an external storage system for storage and safekeeping, the plurality of pertinent data artifacts includes video data, audio data, images, a GPS location, a timestamp, a date stamp, an International Mobile Equipment Identity (IMEI), an International Mobile Subscriber Identity (IMSI), an Mobile Equipment Identifier (MEID), an Service Set Identifier SSID, an Electronic Serial Number (ESN), a Bluetooth® identification number, a Wi-Fi identification, a MAC (Media Access Control) addresses, or a combination thereof.

In still yet another aspect of the present embodiment, a method of identifying one or more potential perpetrators and witnesses of a crime controlled by an electronic fingerprints application and executed by an electronic fingerprint capturing device, the method including the steps of placing the electronic fingerprint capturing device in a data acquisition mode upon detection of a trigger activation mechanism, the electronic fingerprint capturing device includes a display, a microprocessor, a memory component for storing software application data, a data entry component, a network communication device, a video audio capture device, a microphone, a speaker, an accelerometer, and a GPS module; systematically collecting and capturing a plurality of pertinent data artifacts relevant to the crime when the electronic fingerprint capturing device is within the transmission capture range of one or more mobile devices carried by the one or more potential perpetrators and witnesses; and communicating and transferring the plurality of pertinent data artifacts to an external storage system for storage and safekeeping, the plurality of pertinent data artifacts includes video data, audio data, images, a GPS location, a timestamp, a date stamp, an International Mobile Equipment Identity (IMEI), an International Mobile Subscriber Identity (IMSI), an Mobile Equipment Identifier (MEID), an Service Set Identifier SSID, an Electronic Serial Number (ESN), a Bluetooth® identification number, a Wi-Fi identification, a MAC addresses, or a combination thereof.

These and other objects, features and advantages of the present invention will become more apparent in light of the following detailed description of preferred embodiments thereof, as illustrated in the accompanying drawings.

### BRIEF DESCRIPTION OF THE DRAWINGS

The present invention will be more clearly understood from the following detailed description of the preferred embodiments of the invention and from the attached drawings, in which:

FIG. 1 illustrates various types of electronic fingerprint capturing devices for capturing of electronic fingerprints, in accordance to an embodiment.

FIG. 2 illustrates a block diagram outlining the events that occur once the electronic fingerprint application operating on the electronic fingerprint capturing device is activated, portraying the capturing of electronic fingerprints, in accordance to an embodiment.

FIG. 3 illustrates a block diagram of trigger activation mechanisms in which the electronic fingerprint application on the electronic fingerprint capturing device can be activated by the user, in accordance to an embodiment.

FIG. 4 illustrates a block diagram containing the various electronic fingerprints that the electronic fingerprints application may detect, search for and collect upon activation, in accordance to an embodiment.

FIG. 5 illustrates a flowchart of the processing steps performed by the electronic fingerprints application to activate a data acquisition mode in the electronic fingerprint capturing device, in accordance to an embodiment.

FIG. 6 illustrates a flowchart of the process performed by the electronic fingerprints application, in accordance to an embodiment.

FIG. 7 illustrates a block diagram of data artifacts collected by the electronic fingerprints application, according to an embodiment.

FIG. 8 illustrates a block diagram of the mobile devices of potential criminal or witness with electronic fingerprint connected to typical communication network, according to an embodiment.

FIG. 9 illustrates a flowchart of a typical software defined radio receiver, according to an embodiment.

FIG. 10 illustrates a flowchart of obtaining electronic fingerprints via software defined radio receiver, according to an embodiment.

FIG. 11 illustrates a table containing an example of a sample of scanned network id and data collected from nearby mobile devices.

FIG. 12 illustrates a block diagram of an example electronic fingerprint capturing mobile device configuration, according to an embodiment.

In the appended figures, one or more elements may have the same reference numeral in different figures indicating previously described elements.

### DETAILED DESCRIPTION OF THE INVENTION

The present embodiment utilizes the ubiquitous mobile devices routinely carried by the masses everywhere to capture information vital to the successful investigation and prosecution of crimes. The present embodiment is a well-rounded solution to this problem of having scarce information in regard to criminal activity. The deployment of this embodiment can empower users to ensure that in the case that he or she feels threatened, the embodiment performs a specific process in which it can systematically and simultaneously dial a preset emergency service number and capture audio, video, images, record accurate GPS location, time, date, and all nearby electronic fingerprints along with their associated signal strength relative to the device running the application and connectivity records. Once the data is captured, it is immediately sent to an online database that can only be accessed by law enforcement in the event a crime is committed and subsequent criminal investigation. This information received cold include the signal of the criminal, criminals, accomplices, and potential witnesses due to their possession or use of wireless devices on their person or in the immediate area.

As used herein, the term electronic fingerprints refer to the various electronic signals that mobile and other wireless devices transmit. Some, but not all electronic fingerprints include but is not limited to International Mobile Equipment Identity (IMEI), international mobile subscriber identity (IMSI), mobile equipment identifier (MEID), service set identifier SSID, electronic serial number (ESN), Bluetooth® and Wi-Fi, MAC addresses and any other electronic fingerprints that are uniquely identifiable and traceable communication device hardware detected within the immediate area along with its signal strength data to establish proximity of each device captured relative to the potential victim's device running or central monitoring device (as in the case of the application operating on a device protecting a home or business).

In sum, described and presented herein is a method and device that facilitates the investigation and prosecution of crime perpetrated on a person, persons, or physical property by systematically collecting and preserving pertinent artifacts relevant to the crime at the time it was committed. The artifacts collected may include, but not limited to, date, time, audio, video, photographic, location the crime was committed as well as collection of electronic fingerprints of all ubiquitous electronic devices in the immediate area and their proximity to the crime ranging from Bluetooth®, Wi-Fi, MIMO and/or Mobile phone, tablet or other wireless device identification and connectivity records. All of the collected data is then stored in an online database and is used to establish proximity of each device captured relative to the potential victim's device utilizing said method. This data can later be used by law enforcement to facilitate the investigation of the crime by establishing when and where the crime was committed, what transpired, who may have been involved, and who may have witnessed the crime. Artifact collection can be initiated in response to a covert or overt queue including, but not limited to, verbal command, physical contact closure, electrical switch contact closure, specific key sequence, screen swipe pattern, physical motion or other sensor activation including, but not limited to, glass breakage sensor, or other physical sensor.

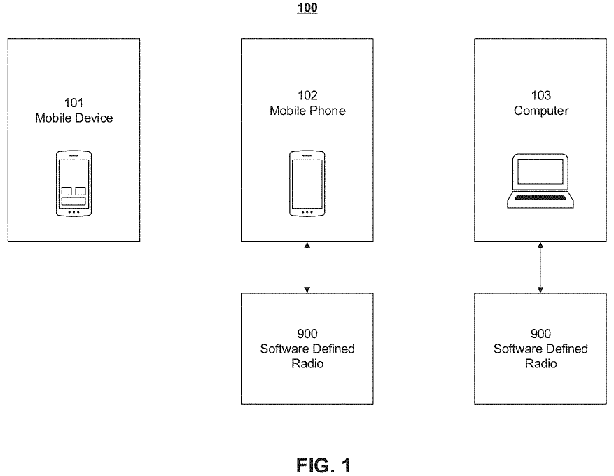

FIG. 1 illustrates various types of electronic fingerprint capturing devices 100 for capturing of electronic fingerprints in accordance to an embodiment. These devices may include, but not limited to 1) a mobile device 101 with built-in and pre-installed electronic fingerprints firmware or software application; 2) a mobile device such as a smart phone 102, or 3) a computer device 103. These mobile and computing devices may include, for example, desktop computers, laptops, tablet, notebook computers, and smart home devices, personal health monitoring systems, and other devices capable of wired or wireless internet communication. The only difference between the mobile device and the computer-based versions is the method of activating the application which is based on certain trigger activation mechanism as will be described later. In addition, these electronic fingerprint capturing devices 100 may include an electronic fingerprints application including, for example, a software program, a mobile application (mobile “APP” or smart app), or a built-in firmware code for controlling, monitoring, and executing functions and features related to the analyzing, processing and capturing of electronic fingerprints. The electronic fingerprints application may be installed on the electronic fingerprint capturing devices 100 via direct download, built-in firmware instructions, or manual installation. Basic components of the electronic fingerprint capturing devices 100 may include a display, an input device such as a mouse, data entry component such as a physical or virtual keyboard, or touchscreen, memory, external storage (microSD card, USB flash drive, hard drive), a wired or wireless communication device, a video and audio capture device such as a camera and microphone, and a speaker. Other components may include onboard sensors such as, for example, an accelerometer to measure non-gravitational acceleration, a GPS module for location tracking, and other specialized sensors for monitoring the external environment such as temperature, motion, and other measurable and detectable events that may occur in the environment.

Furthermore, mobile device 101 contains a software defined radio 900 in order to perform electronic fingerprint data collection. Regarding mobile phone 102 and computer 103, an external software defined radio 900 may be utilized at this moment in time in order to have adequate components that are typically not present; however, mobile phone 102 and/or computer 103 may be fitted to contain a software defined radio 900 in the future.

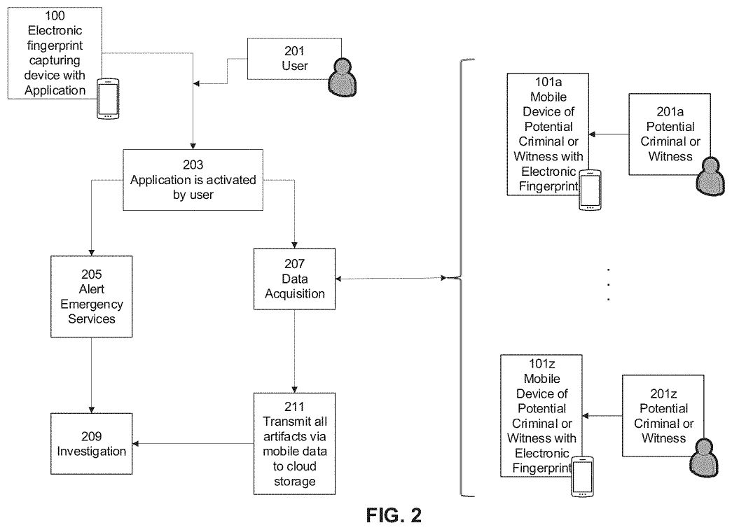

FIG. 2 illustrates a block diagram outlining the events that occur once the electronic fingerprints application operating on the electronic fingerprint capturing device 100 is activated, portraying the capturing of electronic fingerprints in accordance to an embodiment. The electronic fingerprints application may be implemented on the electronic fingerprint capturing device to control, monitor, and execute components in the electronic fingerprint capturing device for recording and processing the electronic fingerprints. In FIG. 2, the electronic fingerprint capturing device 100 with the electronic fingerprints application installed may be operated by a user 201. In practice, activation 203 of the electronic fingerprints application by the user 201 may be performed manually. Once activated, the electronic fingerprints application may automatically operate as a background process until terminated by the user 201. In operation, electronic fingerprints application may perform automatic activities such as contacting and alerting Emergency Services 205, performing data acquisition and collection 207 from nearby mobile electronic devices (101a-101z) belonging to potential criminals or witnesses (201a-201z), transmitting, and storing collected data at an external server at a cloud storage device 211, and providing a source of collected data to investigators from the current location.

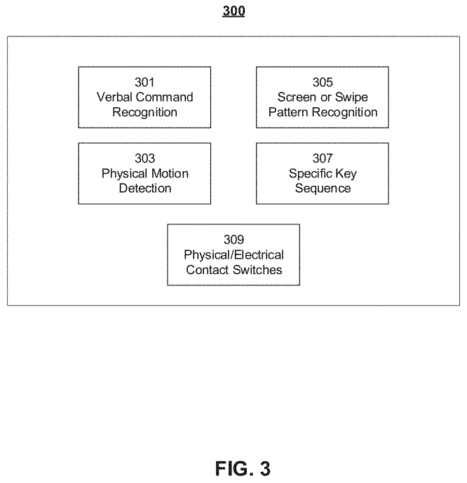

FIG. 3 illustrates a block diagram of trigger activation mechanisms 300 in which the electronic fingerprints application on the electronic fingerprint capturing device 101 can be activated by the user 201, in accordance to an embodiment. These trigger activation mechanisms may include, but not limited to, verbal command recognition 301 which may have overt or covert meaning, physical motion detection 303, display screen or swipe pattern recognition 305, entering of specific key sequences 307, and or physical/electrical switch contact closure, 309. In one implementation, a method of trigger activation in the electronic fingerprint capturing device 100 configuration may include a covert Verbal Command Recognition 301 without alerting the perpetrator to the activation. The covert verbal command may be based on a list of pre-set verbal commands used by the electronic fingerprints application, utilizing the built-in microphone of the electronic fingerprint capturing device 100 to listen for a phrase or word defined in the list of pre-set verbal commands. Some examples of a possible verbal commands include, but are not limited to: “Please don't rob me”, “Please don't rape me”, “Please don't hurt me/us”, “You're hurting me”, “Take my wallet/purse/money”, or “Take my money and credit cards”. This method of activation may also free the victim from conscience thought and action to activate the electronic fingerprints application by having it recognize and respond to situations that may be applicable and warranted without defensive thought or action. Another trigger activation method may be accomplished through Physical Motion Detection 303 of the electronic fingerprint capturing device 100, utilizing built-in accelerometer sensors. In operation, a certain physical motion can be pre-recorded by the user using accelerometer sensors in conjunction with the MEMS (Micro-Electro-Mechanical Systems) based gyroscopes implemented in mobile devices. This may be, but not limited to, spinning the electronic fingerprint capturing device 100 three times around a certain axis or shaking the electronic fingerprint capturing device 100 up and down for three seconds. Another method of trigger activation may be accomplished through pre-recorded screen swipe pattern recognition 305 where the user may record a specific sequence of swipes with his or her finger on the display screen of the electronic fingerprint capturing device 100. The specific sequence of swipes on the display screen may include, for example, a swipe from top to bottom three times or a swipe from each corner two times. One last method of trigger activation may be accomplished through pre-recorded Specific Key Sequence 307 where the user can record him or her create a unique sequence of pressing the buttons on the electronic fingerprint capturing device 100. The unique sequence of pressing the buttons may include, for example, pressing the power button quickly three times or pressing the volume button down then up then down.

The present embodiment may also be adopted to be used within a computer-based security system used within infrastructure such as buildings. In FIG. 3, Physical and or Electrical Contact Switches 309 may be used as physical electrical contact closure mechanisms to launch the electronic fingerprints application, similar to the other methods of trigger activation. In practice, other physical and or electrical contact switches may be applied to launch the electronic fingerprints application including, for example, window and door sensors, smoke and carbon monoxide sensors, pressure and temperature sensors, motion sensors, switches, glass breakage, gunshot sensor, or any other indication of risk to injury, life or property.

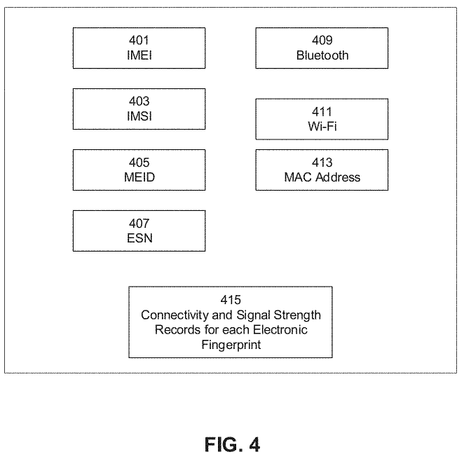

FIG. 4 illustrates a block diagram containing the various electronic fingerprints that the electronic fingerprints application may detect, search for and collect upon activation, in accordance to an embodiment. These electronic fingerprints may include, for example, International Mobile Equipment Identity (IMEI) 401, international mobile subscriber identity (IMSI) 403, mobile equipment identifier (MEID) 405, electronic serial number (ESN) 407, Bluetooth® 409, Wi-Fi 311, and MAC addresses 413. Connectivity and Signal Strength Records for each Electronic Fingerprint 415.

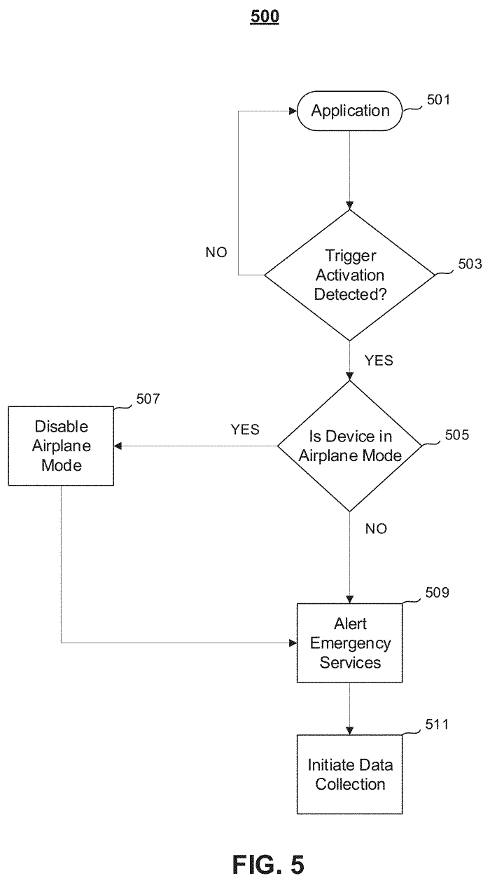

FIG. 5 illustrates a flowchart 500 of the processing steps performed by the electronic fingerprints application to activate a data acquisition mode in the electronic fingerprint capturing device 100 beginning at step 501, utilizing events via decision blocks to monitor the user's input, in accordance to an embodiment. A first decision block (step 503) detects and checks for any of the trigger activation mechanisms 300 that may have been activated, as previously described and shown in FIG. 2. If a trigger activation is detected at step 503, a second decision block (step 505) in the process determines if the electronic fingerprint capturing device 100 is set to “Airplane Mode”. In operation, this mode is typical on most mobile devices that transmit and receive electronic communication signals and is a toggleable option that users may use to disable their mobile phone from transmitting cellular or wireless signals. If “Airplane Mode” is detected at step 505, the electronic fingerprints application disables it at step 507, allowing the electronic fingerprint capturing device 100 to transmit and receive wireless communication to and from external wireless network systems. Thus, regardless of the electronic fingerprint capturing device 100 being in “Airplane Mode”, the electronic fingerprints application will disable it, allowing the device to receive and transmit data. With the cellular and wireless modes enabled on the electronic fingerprint capturing device 100, the electronic fingerprints application may initiate contact with emergency services (step 509) and subsequently initiate data collection (step 511), capturing and recording local parameters, video data, and audio data in the electronic fingerprint capturing device 100 as well as electronic fingerprints from nearby mobile devices as previously presented and described hereinabove and in FIG. 4.

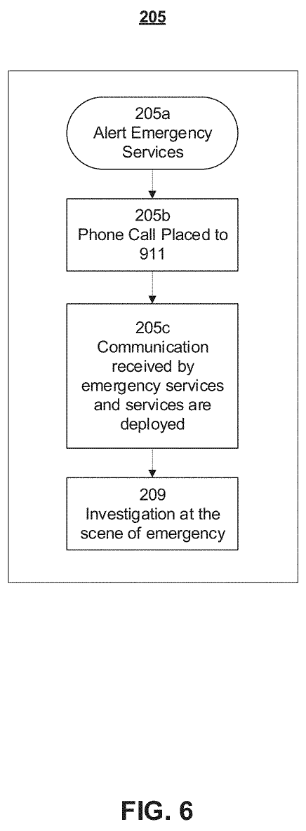

FIG. 6 illustrates a flowchart of the process 205 performed by the electronic fingerprints application as previously presented hereinabove and in FIG. 2, in accordance to an embodiment. Once an alert to emergency services is initiated by the electronic fingerprints application (step 205a), the electronic fingerprint capturing device 100 may be configured to initiate an emergency phone call (step 205b) to a predetermined emergency service phone number. Next, when the emergency phone call is received by the emergency service agency, emergency services may be dispatched to the location of the emergency (step 205c). The electronic fingerprints application may be also configured to record the communication between the user and the victim. Subsequently, investigation at the scene of the emergency (step 209) may involve outside law enforcement parties including detectives, crime scene investigators, and law enforcement personnel. In addition, the information collected may be collected silently without notification to user or emergency services, and the emergency services may be notified following collection and storage of the information collected.

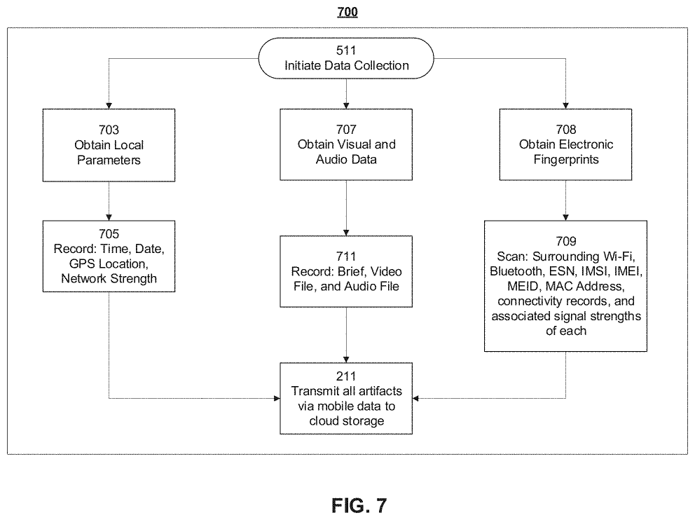

FIG. 7 illustrates a block diagram of data artifacts collected by the electronic fingerprints application 700, according to an embodiment. In FIG. 7, when data collection is initiated 511 after a trigger activation mechanisms 300 has been activated, the electronic fingerprints application may acquire and collect local parameters 703, recording the time, date, and geographical position utilizing internal clock circuitry and GPS circuitry 705 in the electronic fingerprint capturing device 100. Additionally, the electronic fingerprints application may obtain visual and audio data 707 from the electronic fingerprint capturing device 100 where images, video, and audio files will be recorded 711 utilizing the included camera and microphone on the electronic fingerprint capturing device 100. Subsequently, the collected data (time, date, GPS location, mobile device (101a-101z) signal strength, image data, video data, and audio data) is transmitted via a wireless network connection to the online storage center (cloud storage) 211, regardless if all possible data is collected. As soon as each piece of data is obtained, wireless data transmission begins to send to an online storage center, where a digital receipt is given to the user's 201 account on the electronic fingerprint capturing device 100 and sent via electronic mail (email). The digital receipt may contain the date, time, location, battery percent of device, signal strength of device to the network of the provider, and the status of each transmission of artifacts collected. Note, the digital receipt will not contain the data collected, but only the parameters of the data collection and transmission.

In parallel, the electronic fingerprints application is configured to obtain electronic fingerprints 708 by scanning for nearby mobile devices, capturing and recording electronic fingerprints 709 in the nearby area. These electronic fingerprints as discussed previously in FIG. 4 may include IMEI, IMSI, MEID, SSID, ESN, Bluetooth® and Wi-Fi, MAC addresses and any other uniquely identifiable and traceable communication device hardware detected within the immediate vicinity along with its signal strength data to establish proximity of each device captured relative to the potential victim's mobile device running the electronic fingerprints application. The captured electronic fingerprints are subsequently transmitted via the wireless network connection to the online storage center (cloud storage) 211 following a similar transmission process as previously described. As soon as an electronic fingerprint is obtained, it begins transmission to an online storage center. Not only is the data content sent, but the strength of that signal is sent as well. Once the data is received at the online storage center, a second digital receipt is given to the user's account on the device and sent via electronic mail. The second digital receipt may contain the date, time, location, battery percent of device, signal strength of device to the network of the provider, and the status of each transmission of artifacts collected. Note, this receipt will not contain the data collected, but only the parameters of the data collection and transmission.

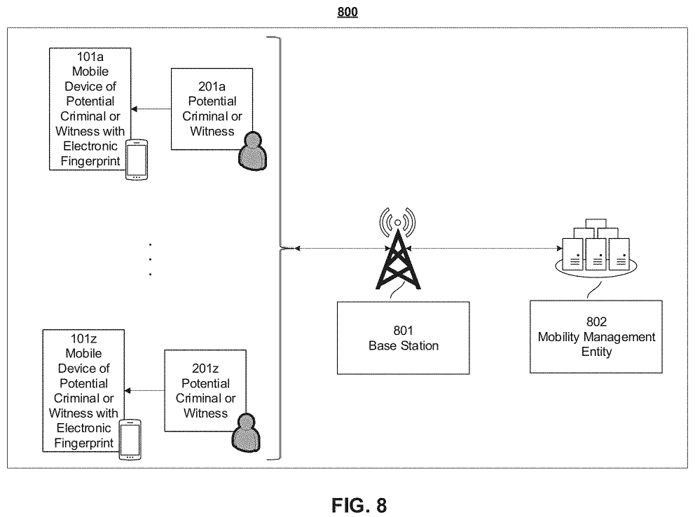

FIG. 8 illustrates a block diagram of a typical communication network that a mobile device of potential criminal or witness with electronic fingerprint (101a-101z) belonging to potential criminals or witnesses (201a-201z) with a base station 801 and Mobility Management Entity (MME) 802. A mobile device of potential criminal or witness with electronic fingerprint (101a-101z belonging to potential criminals or witnesses (201a-201z) continuously connect to the strongest base station 801 which includes personal information relating to the ownership of the device. This data relates the physical device to a person or entity and must be verified by the MME 802 in order to enable communication with the service provider.

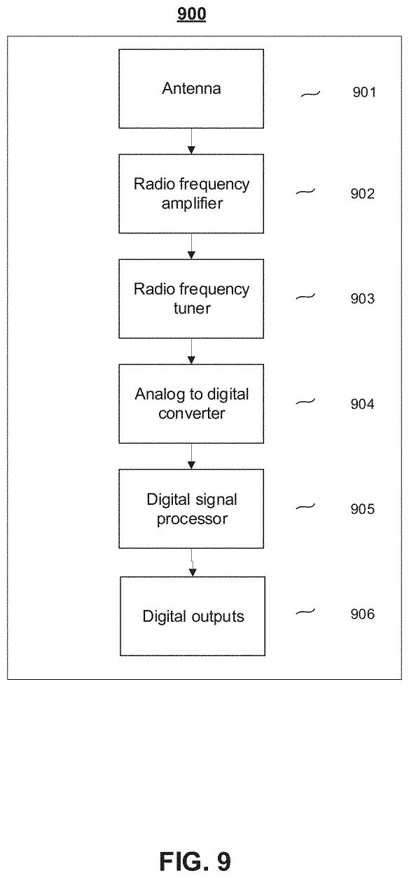

FIG. 9 illustrates a block diagram of the typical components that constitute a software defined radio (SDR) receiver. An antenna 901 receives electromagnetic radio signals used for a communication network. A radio frequency amplifier 902 to increase the power of the received signal for further processing and filtering. A radio frequency tuner 903 converts the selected carrier frequency and its associated bandwidth into a fixed frequency for further processing. An analog to digital converter 904 changes the analog electromagnetic signal to digital values for processing. A digital signal processor 905 performs mathematical operations to demodulate the information impressed on the electromagnetic radio signals to recover the digital data for further processing and filtering. The digital outputs 906 are recovered from the SDR receiver for further processing and storage 211.

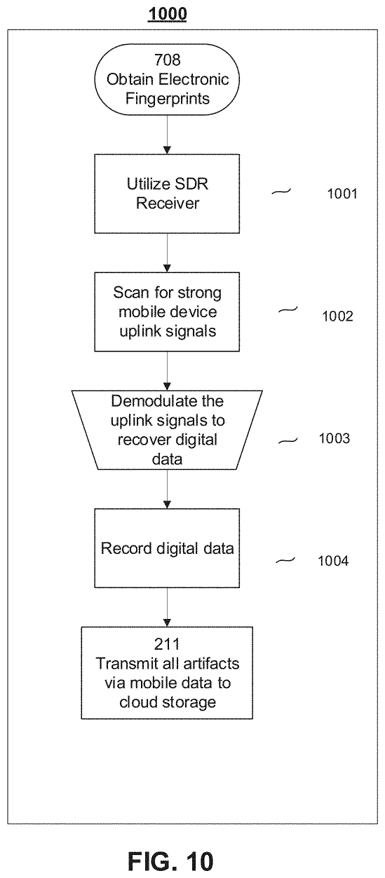

FIG. 10 illustrates a block diagram of the collection of electronic fingerprints discussed in obtain electronic fingerprints 708 regarding data collection. Once electronic fingerprints are to be collected, the SDR 1001 and its components antenna 901, radio frequency amplifier 902, radio frequency tuner 903, analog to digital converter 904, digital signal processor 905, and digital outputs 906 are utilized for data collection. The SDR receiver 900 will scan for strong (close proximity) mobile device uplink signals, Wi-Fi signal, and/or Bluetooth® signals 1002 and then demodulate the signals to recover digital data 1003 in order to receive the pertinent electronic fingerprints and record 1004 to storage 211.

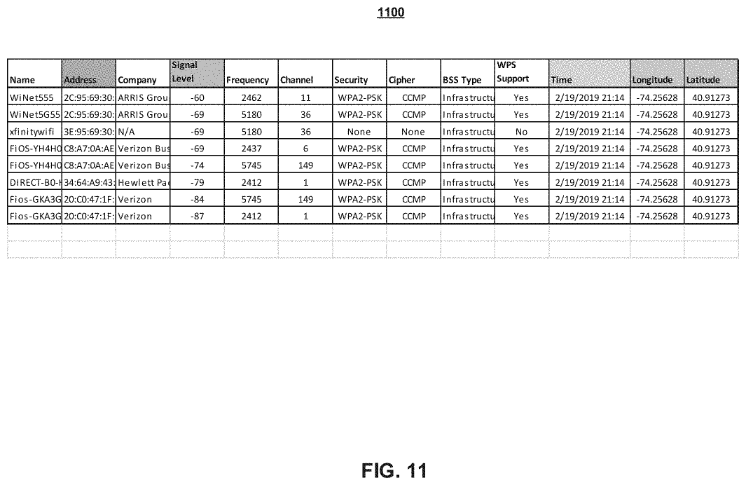

FIG. 11 comprises a table 1100 containing an example of a scanned environment capturing network id and data collected from nearby mobile devices. An example of implementation of performing a scan of an environment is done via free application, Netstumbler and should be understood that this software application is only an example and not necessarily how the system might actually be implemented. In this table 1100, the gathering and storage of Wi-Fi data may be stored. Note, the user 201 may not have access to the data once recorded. The data may or may not be encrypted to obscure user identity or traceability by public user, 201, but accessible to law enforcement with appropriate authorization such as court order or search warrant. Regardless, this example generally portrays the amount of data that is openly available to be captured by an electronic fingering device such as the mobile device 101. In FIG. 11, this data may portray the ability to not only record addresses, but to record logical and physical device signal strength, location, frequency, channel, and manufacturer information. Although the type of data presented in FIG. 11 are from Wi-Fi routers, other data types, such as IMEI, IMSI, MEID, SSID, ESN, and other identification parameters from IoT devices, such as smart devices, may be accessed and decrypted or decoded by law enforcement after approaching and compelling a mobile phone service provider to divulge the necessary key after serving appropriate authorization such as court order or search warrant. Subsequently, law enforcement agencies may have access to the electronic fingerprints data collected, which is stored in the cloud 211, and determine the owner of the electronic fingerprints data via mobile device's service provider records. It should be noted that if some of the electronic fingerprints cannot be received by a typical mobile device, it is possible that more types of data will be openly transmittable and receivable in the future or specifically added to mobile devices to facilitate identification of physical hardware. Again, this data may or may not be encrypted or coded to prevent unauthorized disclosure of user identification or traceability which would require law enforcement to serve appropriate authorization to recover this data as was previously stated.

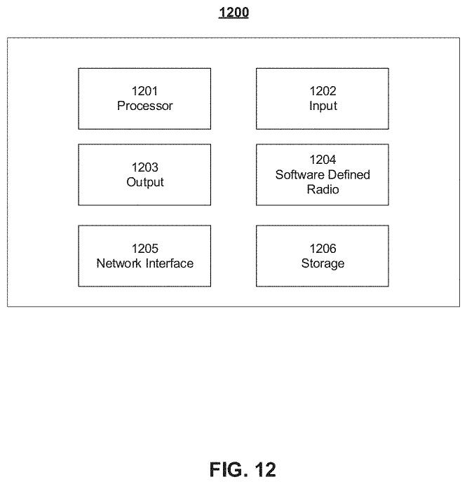

FIG. 12 illustrates a block diagram of an example configuration 1200 of the electronic fingerprint capturing devices 100. The number, identity, and arrangement of elements in the configuration 1200 are not limited to what is shown, and additional and/or different elements may be contained in or coupled to the elements shown. The configuration 1200 is an example only, and the electronic fingerprint capturing devices 100 can be configured in other ways. In the example configuration 1200, the electronic fingerprint capturing devices 100 may include various components, such as a processor 1201, input 1202, output 1203, software defined radio 1204, network interface 1205, and storage 1206. The network interface 1205 may facilitate connectivity with a network, such as 801, Bluetooth®, and/or Wi-Fi. The processor 1201 routes information between components within the electronic fingerprint capturing device and executes actions stored in the storage 1206. The software defined radio, 1204 may serve as receiver or transceiver as is necessary to communicate with mobile device of potential criminal or witness with electronic fingerprint (101a-101z) belonging to potential criminals or witnesses (201a-201z) to broadcast their respective and unique and traceable electronic fingerprints such as, but not limited to, IMEI, IMSI, MEID, SSID, ESN, Bluetooth®, MAC Addresses, and Wi-Fi addresses, and signal strength of each electronic devices.

The output 1203 enables information such as text, images, and media to be shown via display mechanisms such as cathode ray tube, liquid crystal, light emitting diode, laser, and other display mechanisms. The input 1202 includes components such as keyboard, a mouse, microphone, accelerometer, and/or touch screen. Furthermore, the input 1202 is represented by the trigger activation mechanisms 300 in which the electronic fingerprints application on the electronic fingerprint capturing device 101 can be activated by the user 201, in accordance to an embodiment. These trigger activation mechanisms may include, for example, overt/covert verbal command recognition 301, physical motion detection 303, display screen or swipe pattern recognition 305, entering of specific key sequences 307, and or physical/electrical contact switches 309, completing an electrical circuit closure to signal activation of the fingerprint capturing device to initiate data collection 511.

The network interface 1205 in the electronic fingerprint capturing device enable communication between a peripheral device and/or network, such as 801, LTE, Bluetooth®, and/or Wi-Fi. For example, the peripheral devices may include a microphone, speaker, accelerometer, software defined radio receiver, mouse, etc.) and may include physical connection ports such as Universal Serial Bus (USB).

The storage 1206 may include mass storage and/or cache memory for the electronic fingerprint capturing application which is described in FIG. 5, FIG. 7, and FIG. 10. The storage may be implemented by solid state elements, magnetic elements, and/or organic elements. The storage 1206 may consist of random access memory (RAM), flash RAM, read-only memory (ROM), erasable programmable read-only memory (EPROM), and electrically erasable programmable read-only memory (EEPROM). The storage 1206 may store program code for various applications, an operating system (Windows® XP, Linux® OS, etc.), and/or other executable instructions.

An example of implementation of the fingerprint capturing device should be understood that this only an example is not necessarily how the system might actually be implemented. A mobile device with the electronic fingerprint capturing device stored in memory 100 such as a host laptop (Intel i7 processor and Ubuntu 14.04 operating system). As described by FIG. 10, an SDR receiver must be used such as a Universal Software Radio Peripheral (USRP B210) in order to simulate a base station 801. Similarly, an SDR (RTL-SDR) can also be used passively. The USRP or SDR is connected to the host laptop. It should be understood the SDR function could be embedded within the mobile device, 102 or laptop, 103 for future embodiment. For this example implementation, the Long Term Evolution (LTE) network is used, but can also be performed on other networks such as Global System for Mobiles (GSM). In order to utilize an USRP B210, a free and open-source library such as “OpenLTE” to communicate with the USRP B210 and includes LTE specifications to execute LTE attach procedure between the electronic fingerprint capturing device and nearby mobile devices 101. A free and open-source program such as Wireshark is utilized to scan for strong, nearby mobile device uplink signals 1002 and demodulates the uplink signals 1003 to recover the unique and traceable electronic fingerprints digital data such as, but not limited to, IMEI, IMSI, MEID, SSID, ESN, Bluetooth®, MAC Addresses, and Wi-Fi addresses, and signal strength of each electronic devices 1004 and transmitted to cloud storage 211.

Regardless whether the electronic fingerprints application was operated on the mobile device 101, the mobile device 102 or the computer 103, the method that the user 201 may utilize to launch the electronic fingerprints application the data stored in the cloud by the electronic fingerprints application may or may not be configured to automatically notify law enforcement, emergency services, or family members of a missing person when application is activated. The data stored in the cloud may be partially or wholly restricted to law enforcement. May or may not be encrypted or encoded to obscure and protect user identification without proper authorization such as court order to address privacy concerns.

The investigation due to the artifacts from the present embodiment is able to create a list of likely possible identities due to the signals in the proximity of the application being utilized. Primarily, the electronic fingerprints application may rank and filter all of the signals by the strength of each signal with respect to the device running the application. The stronger the signal, ranked in increasing absolute value of the signal strength, usually indicates a closer proximity (e.g., signal with the largest magnitude is the strongest). Furthermore, the strongest signals stored may belong and be isolated to the perpetrator of crime in question or witnesses thereof. For example, the present invention may be used to narrow down and filter signals in a very dense area by ranking the strength of each signal. Additionally, each type of electronic fingerprint can be searched within a library, provided by manufactures and mobile phone providers, which over time, can associate electronic fingerprints to a name, address, social security number or other identifying feature.

In the event that the criminals or witnesses may not have any traceable devices that transmit data, the present invention may still be crucial and relevant. Moreover, capturing the data of potential witnesses and bystanders within the nearby vicinity that may possess devices that transmit unique and traceable electronic fingerprints to assist and help law enforcement investigators in determining who may have witness those responsible for such harmful and/or criminal acts. Similarly, if captured data from potential criminals is corrupt or unavailable, the invention employed by the victim's mobile device 100 will be able to capture unique and traceable electronic fingerprints of bystanders in the nearby area for law enforcement to attempt to receive information for law enforcement to later identify possible witnesses to the crime. It is noted that the invention and use thereof is not responsible for determining how law enforcement will use any of the captured and stored data.

In another embodiment, the present invention may also utilize the mobile device's speaker to send out an audible message that declares that artifacts have been collected, alerting perpetrators and bystanders that the electronic fingerprints application has been activated and successfully saved its cache of data acquired to the cloud storage. This may be included in the electronic fingerprints application as an optional implementation for the purpose of motivating the perpetrator to cease and desist from any further aggression, destruction or theft of property for more favorable legal treatment.

As used in the specification and the appended claims, the singular forms “a”, “an”, and “the” included plural referents unless the context clearly dictates otherwise.

All patents, patent applications, and other references cited herein are incorporated by reference in their entireties.

It is noted that the foregoing disclosure has been provided merely for the purpose of explanation and is in no way to be construed as limiting of the present invention. Although the present invention has been shown and described with respect to several preferred embodiments thereof, various changes, omissions, and additions to the form and detail thereof, may be made therein, without departing from the spirit and scope of the invention. It is understood that the words which have been used herein are words of description and illustration, rather than words of limitation. Changes may be made, within the purview of the appended claims, as presently stated and as amended, without departing from the scope and spirit of the present invention in its aspects.

Other embodiments and modifications of the present invention may occur to those of ordinary skill in the art in view of these teachings. Accordingly, the invention is to be limited only by the following claims which include all other such embodiments and modifications when viewed in conjunction with the above specifications and accompanying drawings.

What is claimed is:

1. An electronic fingerprint capturing device for identifying one or more potential perpetrators and witnesses of a crime, the electronic fingerprint capturing device comprising:
a display, a microprocessor, a memory component for storing software application data, a data entry component, a network communication device, a video audio capture device, a microphone, a speaker, an accelerometer, and a GPS module; and
an electronic fingerprints application installed in the memory component by a user and executed by the microprocessor, wherein the electronic fingerprints application is configured to be activated by the user, wherein the electronic fingerprints application causes the microprocessor to:
place the electronic fingerprint capturing device in a data acquisition mode upon detection of a trigger activation mechanism;
systematically collect and capture a plurality of pertinent data artifacts relevant to the crime when the electronic fingerprint capturing device is within a proximate transmission capture range of the one or more mobile devices carried by the one or more potential perpetrators and witnesses; and
communicate and transfer the plurality of pertinent data artifacts to an external storage system for storage and safekeeping, wherein the plurality pertinent data artifacts includes an International Mobile Equipment Identity (IMEI), an International Mobile Subscriber Identity (IMSI), an Mobile Equipment Identifier (MEID), an Service Set Identifier SSID, an Electronic Serial Number (ESN), a Bluetooth® identification number, a Wi-Fi identification, a MAC addresses, or a combination thereof.

2. The electronic fingerprint capturing device of claim 1, wherein the electronic fingerprints application causes the microprocessor to alert emergency services.

3. The electronic fingerprint capturing device of claim 2, wherein the plurality of pertinent data artifacts is collected silently without notification to the user or the emergency services.

4. The electronic fingerprint capturing device of claim 2, wherein the emergency services are notified following the collection and storage of the plurality of pertinent data artifacts.

5. The electronic fingerprint capturing device of claim 1, wherein the electronic fingerprint capturing device is a mobile device, a smartphone device, or a computer device.

6. The electronic fingerprint capturing device of claim 1, wherein the trigger activation mechanism includes an overt verbal command recognition.

7. The electronic fingerprint capturing device of claim 1, wherein the trigger activation mechanism includes a covert verbal command recognition.

8. The electronic fingerprint capturing device of claim 1, wherein the trigger activation mechanism includes a display touchscreen swipe or a pattern recognition.

9. The electronic fingerprint capturing device of claim 1, wherein the trigger activation mechanism includes a process of entering of specific key sequences on the data entry component.

10. The electronic fingerprint capturing device of claim 1, wherein the trigger activation mechanism includes physical or electrical contact switches.

11. A method of identifying one or more potential perpetrators and witnesses of a crime controlled by an electronic fingerprints application and executed by an electronic fingerprint capturing device, the method comprising:
placing the electronic fingerprint capturing device in a data acquisition mode upon detection of a trigger activation mechanism, wherein the electronic fingerprint capturing device includes a display, a microprocessor, a memory component for storing software application data, a data entry component, a network communication device, a video audio capture device, a microphone, a speaker, an accelerometer, and a GPS module;
systematically collecting and capturing a plurality of pertinent data artifacts relevant to the crime when the electronic fingerprint capturing device is within a proximate transmission capture range of one or more mobile devices carried by the one or more potential perpetrators and witnesses; and
communicating and transferring the plurality of pertinent data artifacts to an external storage system for storage and safekeeping, wherein the plurality pertinent data artifacts includes an International Mobile Equipment Identity (IMEI), an International Mobile Subscriber Identity (IMSI), an Mobile Equipment Identifier (MEID), an Service Set Identifier SSID, an Electronic Serial Number (ESN), a Bluetooth® identification number, a Wi-Fi identification, a MAC addresses, or a combination thereof.

12. The method of claim 1, wherein the electronic fingerprints application causes the microprocessor to alert emergency services.

13. The electronic fingerprint capturing device of claim 12, wherein the plurality of pertinent data artifacts is collected silently without notification to the user or the emergency services.

14. The electronic fingerprint capturing device of claim 12, wherein the emergency services are notified following the collection and storage of the plurality of pertinent data artifacts.

15. The method of claim 1, wherein the electronic fingerprint capturing device is a mobile device, a smartphone device, or a computer device.

16. The method of claim 1, wherein the trigger activation mechanism includes an overt verbal command recognition.

17. The method of claim 1, wherein the trigger activation mechanism includes a covert verbal command recognition.

18. The method of claim 1, wherein the trigger activation mechanism includes a display touchscreen swipe or a pattern recognition.

19. The method of claim 1, wherein the trigger activation mechanism includes a process of entering of specific key sequences on the data entry component.

20. The method of claim 1, wherein the trigger activation mechanism includes physical or electrical contact switches.
